(19) United States
(12) Patent Application Publication
(10) Pub. No.: US 2008/0162236 A1
(43) Pub. Date: Jul. 3, 2008

(54) Method for trust management in complex organizations

(76) Inventor: Peter Sommerer, Kanata (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/646,391

(22) Filed: Dec. 28, 2006

(51) Int. Cl. G06Q 10/00; G06F 17/10

(52) U.S. Cl. 705/8; 705/7

(57) ABSTRACT

Complex organizations include a plurality of parties, including some parties whose financial performance relies upon the behavior of another party meeting an expectation of trust. A method of managing trust relationships within a complex organization includes determining a dependency value relating to an extent to which the financial performance of a first party of the plurality of parties relies upon the behavior of a second party of the plurality of parties, and determining a trust value relating to a level of trust that the first party holds in the second party. A risk value is then determined based upon the determined trust value. Next, a cost impact value is determined, which is based upon the determined dependency value, the determined risk value, and a scaling factor relating to an extent to which the first party's compensation is tied to its financial performance. Next, an action is performed for reducing the determined cost impact value.

### FIELD OF THE INVENTION

The instant invention relates generally to management in complex organizations, and more particularly to a method for trust management in complex organizations.

### BACKGROUND

Trust building measures within organizations are many times considered as frivolous and unnecessary, because they appear to be ‘touchy-feely’, fuzzy and not measurable. Trust is a very simple and powerful word, yet it defies a simple definition. That being said, there is little doubt that trust is a key ingredient of any social system. Trust, which meets its expectations, makes social interactions less complex and far less costly, as it replaces otherwise necessary social instruments. However, trust, which does not meet its expectations, does result in the social costs of such unmet expectations, which could have been avoided, had other social measures been used in the first place.

Millions of individuals make decisions, whether to trust or not to trust, every day without putting ‘real’ numbers to this seemingly simple decision scenario, letting themselves be guided instead by amorphous unstructured, unverified and extremely subjective considerations.

This almost exclusively subjective approach to the issue of the use of trust also pervades the supposedly rational world of business. The language used in the context of trust is the qualitative language of social sciences and not the language of business. A reckoning is emerging though, that trust is more than a social issue for businesses, but that trust is a bottom-line issue.

The status of trust as a management issue has risen with the advent of complex organizations. Generally speaking, a complex organization is one that does not follow the simple organizational principles of the two dominant organization forms—the functional line-staff organization and the divisional organization. The characteristics of each organization form are described in greater detail, below.

The functional organization exploits the increase in efficiencies of coordinated multiple organizational units, each of which specializes in the performance of certain tasks, as described in Kieser & Walgenbach (2003. Organisation, Stuttgart, Germany. Kohlhammer, the entire contents of which is incorporated herein by reference). Units are defined based on similar tasks. The coordination of the units is performed through a hierarchical layer of management. Information and control flow up and down these layers, possibly involving the single, very top layer of the overall manager.

Managers of subordinate units are committed to perform their assigned tasks with utmost efficiency. Managerial discretion at each layer is focused on the Know-How of performing tasks, which are within the confines of each respective unit. The effects of the main decisions made by a unit thus stay within each unit, which eliminates the reliance of management of one unit on the decisions of management of another unit. Hence trust is not an issue between managers of units at the same managerial level.

Management of a unit is however reliant on decisions made by management of a superior unit. However the superior unit is also the unit, which enters into a contract with management of the subordinate unit regarding the performance of the assigned tasks. Management of a subordinate unit thus can take its subjective risk assessment, which includes the level of trust assigned to the management of the superior unit, into account when negotiating the level of compensation to be received. Whether trust is high or low between management of a superior and subordinate units, an equilibrium between perceived risk and compensation can be established, as these two dimensions are directly related in time and substance. While trust is an issue between managers of different levels, it can be managed easily.

The need to exert control over ever larger organizations and the need to play tribute to the diverging nature of businesses in multiple markets led to the advent of the divisional form of organization, as described in Chandler (1962. Strategy and Structure, Cambridge, Mass. MIT, the entire contents of which is incorporated herein by reference). Divisional organizations define units on the basis of products, rather than on the basis of tasks. Each of these units is given control over all resources required to perform the subordinate tasks. A divisional organization at the very top of a company splits such a company into multiple sub-companies, each addressing a separate market and each having its own units to execute the tasks of converting raw inputs into end products. While the overall organization may retain certain central functions, particularly those, which represent the organization to the outside, the ability and resources to sell into distinct markets is the hallmark of the classical divisional organization.

A main reason for creating divisions is the creation of clear responsibilities and the avoidance of conflicts between the differing needs of one division concerning one set of tasks with the needs from another division. Thus divisions too are designed to reduce cross-reliance between managers of two divisions and thus trust is of little importance in divisional organizations.

Complex organizations are all those forms of organization, which are neither functional line-staff nor divisional organizations. Because both functional as well as divisional organizations have evolved into hybrid forms, criteria are needed to draw a distinction between such hybrid functional and divisional organizations and complex organizations. The key criteria for determining if an organization is a complex organization is whether or not financial cross-dependencies exist between managers of units at the same level.

A single-market-multi-product (1MnP) company is one non-limiting example of a complex organization. Such a 1MnP company is made up of a single customer focused business unit, selling to a single market multiple products sourced from multiple product business units, which in turn source their products from a variety of internal or external fulfillment units. In such an organization, management of a product business unit is reliant on the decisions made by management of the customer business unit; management of the customer business unit in turn is reliant on the ability of the product business unit to make available products, which are competitive in price and performance. The resulting dependencies are asymmetrical between the business units and neither dependency can be offset with a risk premium as part of the compensation, because the managers of the cross-dependent business units are not each other's supervisor determining the other's compensation.

In such a situation, trust between the management of the interdependent business units is an important commercial factor, because the respective trust levels become integral to the commercial considerations of each manager, which determine the tactical and strategic decisions made by each manager.

### SUMMARY OF EMBODIMENTS OF THE INVENTION

In accordance with an aspect of the instant invention there is provided a method of managing trust relationships within a complex organization, the complex organization comprising a plurality of parties including some parties whose financial performance relies upon the behavior of another party meeting an expectation of trust, the method comprising: identifying a first party of the plurality of parties whose financial performance relies upon the behavior of a second party meeting an expectation of trust; determining a dependency value relating to an extent to which the financial performance of the first party relies upon the behavior of the second party; determining a trust value relating to a level of trust that the first party holds in the second party; determining a risk value that is based upon the determined trust value; determining a cost impact value that is based upon the determined dependency value, the determined risk value, and a scaling factor relating to an extent to which the first party's compensation is tied to its financial performance; and, performing an action for reducing the determined cost impact value.

In accordance with another aspect of the instant invention there is provided a method of managing trust relationships within a complex organization, the complex organization comprising a plurality of parties including some parties whose financial performance relies upon the behavior of another party meeting an expectation of trust, the method comprising: for each party of the plurality of parties, quantifying separately a dependency value relating to an extent to which the financial performance of that party relies upon the behavior of each other party of the plurality of parties, each non-zero dependency value being indicative of a trust relationship between two parties of the plurality of parties, wherein the two parties include a trusting party and a trusted party; for each trust relationship, determining a trust value relating to a level of trust that the trusting party of the two parties holds in the trusted party of the two parties; for each trust relationship, determining a risk value that is based upon the determined trust value; for each trust relationship, determining a cost impact value that is based upon the determined dependency value, the determined risk value, and a scaling factor relating to an extent to which the trusting party's compensation is tied to its financial performance; analyzing the determined cost impact values in aggregate, the analysis performed according to predetermined criteria for identifying a critical trust relationship between a trusting party of the plurality of parties and a trusted party of the plurality of parties; and, performing an action for one of modifying the critical trust relationship and modifying the effects of the critical trust relationship between the trusting party and the trusted party.

In accordance with another aspect of the instant invention there is provided a method of managing trust relationships within a complex organization, the complex organization comprising a plurality of parties including some parties whose financial performance relies upon the behavior of another party meeting an expectation of trust, the method comprising: determining a dependency value relating to an extent to which the financial performance of a first party of the plurality of parties relies upon the behavior of a second party of the plurality of parties; determining a trust value relating to a level of trust that the first party holds in the second party; determining a risk value that is based upon the determined trust value; determining a cost impact value that is based upon the determined dependency value, the determined risk value, and a scaling factor relating to an extent to which the first party's compensation is tied to its financial performance; and, performing an action for one of modifying the trust relationship and modifying the effects of the trust relationship between the first party and the second party.

In accordance with another aspect of the instant invention there is provided a method of modifying trust relationships within a complex organization, the complex organization comprising a plurality of parties including some parties whose financial performance relies upon the behavior of another party meeting an expectation of trust, the method comprising: identifying a trust relationship including a first party of the plurality of parties whose financial performance relies upon the behavior of a second party meeting an expectation of trust; quantifying a cost impact of dependency and trust levels associated with the trust relationship; performing an action for reducing the cost impact associated with the trust relationship between the first party and the second party; and, evaluating a cost impact change for the trust relationship after performing the action, wherein the cost impact change is indicative of an effectiveness of the action for improving the trust relationship.

### BRIEF DESCRIPTION OF THE DRAWINGS

Exemplary embodiments of the invention will now be described in conjunction with the following drawings, in which similar reference numbers designate similar items:

FIG. 1 is a simplified flow diagram for a method of managing trust relationships within a complex organization, the complex organization comprising a plurality of parties including some parties whose financial performance relies upon the behavior of another party meeting an expectation of trust;

FIG. 2 is a simplified flow diagram for another method of managing trust relationships within a complex organization, the complex organization comprising a plurality of parties including some parties whose financial performance relies upon the behavior of another party meeting an expectation of trust; and,

FIG. 3 is a simplified flow diagram for another method of managing trust relationships within a complex organization, the complex organization comprising a plurality of parties including some parties whose financial performance relies upon the behavior of another party meeting an expectation of trust.

### DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

The underlying principles that govern the economics of trust are presented briefly in the following sections, in order to facilitate a better understanding of the embodiments of the instant invention that are described herein. In general terms, trust, which meets its expectations, makes social interactions less complex and far less costly with costs of C_{T}, as it replaces otherwise necessary social instruments with costs of C_{A}. Trust, which however does not meet its expectations, does result in the social costs of such unmet expectations (C_{T-}), which could have been avoided, had other social measures been used. These relations can be stated as follows:
C_{T}<<C_{A}, if trust expectations are met
C_{A}<C_{T-}, if trust expectations are not met

Whether or not trust expectations will be met is unknown at the time an individual has to make a decision whether to ‘trust’ or whether to employ other social measures to obtain the desired outcome. Consciously or unconsciously an individual will assess the likelihood that trust will meet its expectations (p_{T}), the likelihood that trust will not meet its expectations (1−p_{T}) and the resulting costs (C_{T-}), as well as the costs of any alternative measures (C_{A}), which would be able to replace the use of trust. Accordingly:

Trust=“YES” if pₜ*C_{T}+(1−p_{T})*C_{T-}<C_{A}

To explore the economic impact of low trust levels, it is assumed that individuals exert effort to achieve economic output, if the incentive I expressed as the ratio of output O over the required effort E is greater or equal to a minimum threshold I₀. This in turns means that the expended effort is a function of the expected output and the subjective incentive ratio, such that:

O/E≧I₀

E≦O/I₀

### Furthermore, output O is the residual of the optimum output Oₒₚₜ less the perceived reduction of this optimum output C_{T} due to the risk R caused by the need to trust T.

O=Oₒₚₜ−C_{T}

C_{T}=Oₒₚₜ*R

R=f(T)

In Burt & Knez (1996. Trust and Third Party Gossip. In Kramer & Tyler (Eds.). Trust in Organizations: 68-89. Thousand Oaks. Calif. SAGE, the entire contents of which is incorporated herein by reference), it is suggested that the relationship between the perceived risk and the level of trust is negative and continuous. The observed relationship between economic risk and factors assumed to impact the level of trust can reasonably be modeled using the inverse tangens function, where T is the level of trust expressed as a variable with a range between 0 (no trust) and 1 (maximum trust).

f(T)=1−tan h(T)

This function returns a value of 1 when T=0 and it returns a value of 0.2384 when T=1. To shape the basic tan h function to the results of the research of Burt & Knez, constants rₘₐₓ and rₘᵢₙ are used thus creating the following function, where rₘₐₓ expresses the maximum perceived risk in the total absence of trust and rₘᵢₙ expresses the perceived minimum risk despite maximum trust levels

f(T)=(rₘₐₓ−rₘᵢₙ)/0.761594*(1−tan h(T))+rₘₐₓ−(rₘₐₓ−rₘᵢₙ)/0.761594

The perceived costs of an individual relying on another are thus the product of the optimum outcome deemed to be achievable by the individual Oₒₚₜ times the risk inherent in the lack of certainty that such trusted individual is fulfilling the expectations

C_{T}=Oₒₚₜ*((rₘₐₓ−rₘᵢₙ)/0.761594*(1−tan h(T))+rₘₐₓ−(rₘₐₓ−rₘᵢₙ)/0.761594)

### Comparing the perceived costs at a given trust level with the perceived costs at no trust results in the relative benefits of such incremental trust, as shown in Table 1.

TABLE 1
Relative costs and benefits of varying levels of trust
Relative costs and benefits of varying levels of trust

| | Trust | | | | | | | | | | |
|---|---|---|---|---|---|---|---|---|---|---|---|
| | 0% | 10% | 20% | 30% | 40% | 50% | 60% | 70% | 80% | 90% | 100% |
| tanh(T) | 0.0000 | 0.0997 | 0.1974 | 0.2913 | 0.3799 | 0.4621 | 0.5370 | 0.6044 | 0.6640 | 0.7163 | 0.7616 |
| 1-tanh(T) | 1.0000 | 0.9003 | 0.8026 | 0.7087 | 0.6201 | 0.5379 | 0.4630 | 0.3956 | 0.3360 | 0.2837 | 0.2384 |
| norm. #1 | 0.3283 | 0.2955 | 0.2635 | 0.2326 | 0.2035 | 0.1766 | 0.1520 | 0.1299 | 0.1103 | 0.0931 | 0.0783 |
| costs (%) | 90.0% | 86.7% | 83.5% | 80.4% | 77.5% | 74.8% | 72.4% | 70.2% | 68.2% | 66.5% | 65.0% |
| benefits(%) | 0.0% | 3.3% | 6.5% | 9.6% | 12.5% | 15.2% | 17.6% | 19.8% | 21.8% | 23.5% | 25.0% |
| Incr. Benefits (%) | | 3.3% | 3.2% | 3.1% | 2.9% | 2.7% | 2.5% | 2.2% | 2.0% | 1.7% | 1.5% |

| | |
|---|---|
| R-max: 90% | R-min: 65% |

Table 1 assumes that 100% of the risk perceived by the trusting individual is carried by this individual. In reality however the personal risk carried by a trusting individual is only a portion of the overall risk, as would be the case for example, if an individual were eligible for a performance bonus as a certain percentage of sales. The actual perceived costs related to a certain level of trust are tempered by a cost participation factor cₚ, which brings the perceived costs C_{P} of trust to

C_{P}=cₚ*Oₒₚₜ*((rₘₐₓ−rₘᵢₙ)/0.761594*(1−tan h(T))+rₘₐₓ−(rₘₐₓ−rₘᵢₙ)/0.761594)

From the above formulas one can also derive a formula describing the impact of trust on the level of effort expended by individuals as follows:

E=Oₒₚₜ*(1−f(T))/I₀

This equation suggests that the effort expended by an individual increases with the level of the possible optimum outcome, that the effort decreases with the individual's minimum incentive ratio, and that the effort decreases with lower levels of trust. This equation applies to each relationship of each individual within an organization. The sum total of all efforts expended by all individuals represents the input into the processes used by an organization to achieve its goals. These efforts translate into economic output multiplied by the productivity factors inherent in such organization.

If individuals start to react to low trust levels by reducing their efforts in order to compensate for the reduced expectations, lower outputs will result, which in turn will lead to lowered expectations, thus creating a classic downward spiral of a company's performance.

Kumar (1996. The power of Trust in Manufacturer-Retailer Relationships. Harvard Business Review, November-December: 92-106, the entire contents of which is incorporated herein by reference), describes the positive impact of high-trust amongst members of a supply chain. Amongst other positive influences, Kumar cites that manufacturers, who enjoy high level of trust amongst its retailers, do enjoy 78% higher sales from high-trust retailers as compared to retailers who have low trust for the manufacturer.

Siemrod & Katuscak (2002. Do Trust and Trustworthieness Pay Off? Cambridge, Mass.: National Bureau of Economics Research, the entire contents of which is incorporated herein by reference), went one step further and provided evidence of a significant positive correlation between levels of trust and economic output of national economies thus suggesting the additive power of trust in any social system of any size.

As noted above, trust is a subjective assessment made by individual members of an organization. Due to the subjective nature, a number of approaches exist to measure the level of trust. Literature provides examples of measurements, which rely on answers to a single question to measure levels of trust and mistrust (Burt & Knez, 1996; Siemrod & Katuscak, 2002), and examples of tools, which use an array of questions (Shaw, 1997. Trust in the Balance. San Francisco, Calif. Jossey-Bass; Cummings & Bromiley, 1996. The Organizational Trust Inventory (OTI). In Goold, M. & Campbell, A. 2002. Designing Effective Organizations. San Francisco, Calif. Jossey-Bass; Kumar, 1996), the entire contents of all of which are incorporated herein by reference.

The trust measurement tool developed by Cummings & Bromiley is based on the definition of trust as “an individual's belief or a common belief among a group of individuals that another individual or group (a) makes good-faith efforts to behave in accordance with any commitments both explicit or implicit, (b) is honest in whatever negotiations preceded such commitments, and (c) does not take excessive advantage of another even when the opportunity is available.” (1996:303). Based on this definition Cummings & Bromiley developed a range of questions to measure various aspects of trust and established the reliability and validity of these questions. Cummings & Bromiley use a scale of 1 to 7 for the responses. These scales can be mapped into values between rₘₐₓ and rₘᵢₙ in a number of ways. Assuming equi-distance between the different scale measures and half that difference between zero and the minimum as well as seven and the maximum, the Cummings & Bromiley scales could be mapped into a tan h function as shown in Table 2.

TABLE 2
Mapping of Cummings & Bromiley trust measurements
Relative costs and benefits of varying results of C&M scales

| | C&B scale | | | | | | |
|---|---|---|---|---|---|---|---|
| | 1 | 2 | 3 | 4 | 5 | 6 | 7 |
| Trust | 7% | 21% | 36% | 50% | 64% | 79% | 93% |
| tanh (T) | 0.0713 | 0.2111 | 0.3427 | 0.4621 | 0.5668 | 0.6560 | 0.7299 |
| 1-tanh (T) | 0.9287 | 0.7889 | 0.6573 | 0.5379 | 0.4332 | 0.3440 | 0.2701 |
| norm. #1 | 0.3049 | 0.2590 | 0.2158 | 0.1766 | 0.1422 | 0.1129 | 0.0887 |
| costs (%) | 87.7% | 83.1% | 78.8% | 74.8% | 71.4% | 68.5% | 66.0% |
| benefits (%) | 0.0% | 4.6% | 8.9% | 12.8% | 16.3% | 19.2% | 21.6% |
| incr. Benefits (%) | | 4.6% | 4.3% | 3.9% | 3.4% | 2.9% | 2.4% |

| | |
|---|---|
| R-max: 90% | R-min: 65% |

According to one embodiment of the instant invention, a management tool is provided for the evaluation of the cost effectiveness of trust building measures, and for identifying critical areas in a complex organization to be defused by one or more of (a) reducing the degree of dependency, (b) increasing the level of trust, and (c) reducing the impact of the dependency. In general terms, a management tool according to one embodiment of the instant invention relates to improving trust relationships within a complex organization, the complex organization comprising a plurality of parties including some parties whose financial performance relies upon the behavior of another party meeting an expectation of trust.

The first step involves identifying cross-dependencies. Table 3 shows the structure of a representative ‘dependence matrix’ for a complex organization. The parties listed in the columns and rows are peers without mutual superior-subordinate relationships between each other. The column of the table shows the trusted party, whereas the rows of the table show the trusting party. The rows for each trusting party are populated with a number, which expresses the extent of the financial interdependency.

TABLE 3
Dependence matrix

| | Party 1 | Party 2 | . . . | Party n |
|---|---|---|---|---|
| Party 1 | — | D_{1,2} | . . . | d_{1,n} |
| Party 2 | d_{2,1} | — | . . . | d_{2,n} |
| . . . | . . . | . . . | . . . | — |
| Party n | d_{n,1} | d_{n,2} | . . . | — |

If the behavior of the trusted party does not have any influence on the financial performance of the trusting party, the entry is nil. Although the behavior of the trusted party may impact the financial performance of the trusting party, the entry is nil if the financial performance of the trusting party is not relying on the behavior of the trusted party. The entry into the remaining fields is the difference between the financial performance indicator the trusting party believes could be achieved, if the trusted party behaved in an optimum manner, and the financial performance indicator, if the trusted party behaved in a totally incompetent and untrustworthy manner.

The next step involves identifying trust levels. Table 4 shows the structure of a representative ‘trust matrix’ for a complex organization. The rows for each trusting party are populated with the results of the transformation of the results of the trust measurements using a verified method of measuring trust such as for instance the system described by Cummings & Bromiley (1996).

TABLE 4
Trust matrix

| | rₘₐₓ | rₘᵢₙ | Party 1 | Party 2 | . . . | Party n |
|---|---|---|---|---|---|---|
| Party 1 | | | — | t_{1,2} | . . . | t_{1,n} |
| Party 2 | | | t_{2,1} | — | . . . | t_{2,n} |
| . . . | | | . . . | . . . | . . . | — |
| Party n | | | t_{n,1} | t_{n,2} | . . . | — |

The next step involves identifying risk levels associated with the trust levels. Table 5 shows the structure of a representative ‘risk matrix’ for a complex organization. The rows for each trusting party are populated with the results of the transformation of the field of the ‘trust matrix’ into risk equivalents.

TABLE 5
Risk matrix

| | | | | | |
|---|---|---|---|---|---|
| rₘₐₓ | rₘᵢₙ | Party 1 | Party 2 | . . . | Party n |

| | | | | |
|---|---|---|---|---|
| Party 1 | — | r_{1,2} | . . . | r_{1,n} |
| Party 2 | r_{2,1} | — | . . . | r_{2,n} |
| . . . | . . . | . . . | . . . | — |
| Party n | r_{n,1} | r_{n,2} | . . . | — |

To transform the values contained in the ‘trust matrix’ a formula, such as for instance the following formula, is applied where rₘₐₓ and rₘᵢₙ are determined independently for each trusting party.

f(T)=(rₘₐₓ−rₘᵢₙ)/0.761594*(1−tan h(T))+rₘₐₓ−(rₘₐₓ−rₘᵢₙ)/0.761594

rₘₐₓ is based on the assessment by the trusting party what percentage of the optimum result could be expected, if all of the trusted parties did act in a totally incompetent and untrustworthy manner. rₘₐₓ is determined as the complement of this number to 1 (one). rₘᵢₙ is based on the assessment by the trusting party what percentage of the optimum result could be expected if all of the trusted parties did act in an optimum manner. rₘᵢₙ is determined as the complement of this number to 1 (one).

The next step involves identifying the cost impact of dependency and trust levels. Table 6 shows the structure of a representative ‘cost matrix’ for a complex organization. The rows for each trusting party are populated with the results of the transformation of the fields of the ‘dependency matrix’ and the field of the ‘risk matrix’ into cost equivalents.

TABLE 6
Cost matrix

| | Cₚ | Party 1 | Party 2 | . . . | Party n | Costs |
|---|---|---|---|---|---|---|
| Party 1 | | — | C_{1,2} | . . . | c_{1,n} | Σc₁ |
| Party 2 | | c_{2,1} | — | . . . | c_{2,n} | Σc₂ |
| . . . | | . . . | . . . | . . . | — | — |
| Party n | | c_{n,1} | C_{n,2} | . . . | — | Σcₙ |
| | | | | | | ΣC |

The entries for each field of the ‘cost matrix’ are determined as the product of the entries of the ‘dependence matrix’ with the corresponding entries of the ‘risk matrix’ and the trusting parties cost participation factor cₚ.

C_{P}=cₚ*d*r

### The cost participation factor expresses how the financial performance impacts the compensation of the trusting party, in the form of bonuses, commissions or profit sharing, as a percentage of the total financial cross-dependency.

The resulting cost matrix is useful for a variety of purposes, such as for example i) review of organizational designs, ii) identification of critical dependencies, and iii) justification of trust building measures. Each separate category is discussed briefly, below.

Completion of the steps as outlined above has the effect of making the issues related to trust visible and transparent. This facilitates efforts to design effective organizations, such as described by Goold & Campbell (2002. Designing Effective Organizations. San Francisco, Calif. Jossey-Bass, the entire contents of which is incorporated herein by reference). Steps toward designing effective organizations include reviewing and adjusting the levels of cross-dependencies by e.g. changing the organizational structure by diversifying one dependency into multiple smaller dependencies on more parties, obtaining an overall assessment of the trust levels inside the organization, taking account of basic personal incompatibilities between parties through pro-active planning of management roles and a review job of assignments, and adjusting the design of performance measurement and compensation schemes to take account of necessary and unavoidable cross-dependencies. Such design steps are greatly facilitated when the issues related to trust are visible and transparent.

Critical points of an organizational design are readily identified when the issues related to trust are visible and transparent. Such critical point may lead to a downward spiral of performance of the entire organization when trust issues are not addressed in an appropriate manner. To identify such critical points, the ‘cost matrix’ is scanned for interdependencies where the costs exceed a critical percentage of a trusting party's compensation. Such conditions exist especially where high levels of financial interdependence are coupled with low trust between the parties and with aggressive recognition of financial performance by the reward systems. To defuse such critical areas the organizational dependencies can be changed, the parties can be changed out, targeted trust building measures can be deployed, or the performance measurement and reward system can be adjusted.

Finally, the steps outlined above also facilitate assessment of the financial justification of the use of trust building measures, be they targeted at specific cross-dependencies or at the organization overall. The sum total costs show the costs perceived by parties due to cross-dependencies and trust. These costs do exist, even if they are not directly reflected in the financial statements of organizations. They may show up as increased compensation. But they may be hidden in form of frustration levels and unhappiness of employees, in constant politicking expressing low trust levels leading to excessive organizational instability, or in internal emigration of parties, whose body shows up at work, but not their mind.

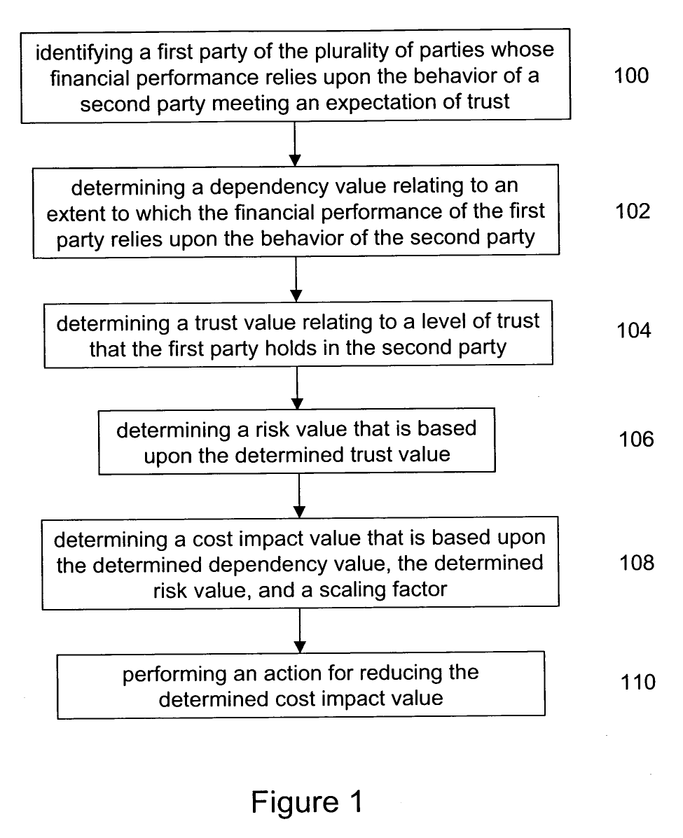

Referring now to FIG. 1, shown is a simplified flow diagram for a method of managing trust relationships within a complex organization, the complex organization comprising a plurality of parties including some parties whose financial performance relies upon the behavior of another party meeting an expectation of trust. At step 100 a first party of the plurality of parties is identified, whose financial performance relies upon the behavior of a second party meeting an expectation of trust, the first party and the second party having a trust relationship. At step 102 a dependency value is determined, the dependency value relating to an extent to which the financial performance of the first party relies upon the behavior of the second party. At step 104 a trust value is determined, the trust value relating to a level of trust that the first party holds in the second party. At step 106 a risk value is determined, the risk value based upon the determined trust value. At step 108 a cost impact value is determined, which is based upon the determined dependency value, the determined risk value, and a scaling factor relating to an extent to which the first party's compensation is tied to its financial performance. At step 110 an action is performed for reducing the determined cost impact value. Some non-limiting examples of actions include:
i) modifying the trust relationship between the first party and the second party;
ii) modifying the effects of the trust relationship between the first party and the second party;
iii) allocating trust building resources for improving the trust relationship between the first party and the second party;
iv) diversifying the first party's dependency on the second party into a plurality of separate dependencies on a plurality of separate parties, each of the plurality of separate dependencies being a one-to-one dependency and having a cost impact value that is smaller than the cost impact value associated with the first party's dependence upon the second party;
v) adjusting a performance measurement and reward system so as to reduce the scaling factor relating to an extent to which the first party's compensation is tied to its financial performance;
vi) removing one of the first party and the second party from the trust relationship; and,
vii) assessing the financial justification of the use of trust building measures for improving trust relationships including the trust relationship between the first party and the second party.

In more particular terms, the risk value f(T) is determined for instance using the formula

f(T)=(rₘₐₓ−rₘᵢₙ)/0.761594*(1−tan h(T))+rₘₐₓ−(rₘₐₓ−rₘᵢₙ)/0.761594

where rₘₐₓ and rₘᵢₙ are determined independently for the first party such that rₘₐₓ expresses the maximum perceived risk in the total absence of trust and rₘᵢₙ expresses the minimum perceived risk despite maximum trust, and T is the determined trust value. In addition, the cost impact value is determined for instance using the formula

Cₚ=cₚ*d*r

where Cₚ is the cost impact value, cₚ is the scaling factor relating to an extent to which the first party's compensation is tied to its financial performance, d is the determined dependency value, and r is the determined risk value.

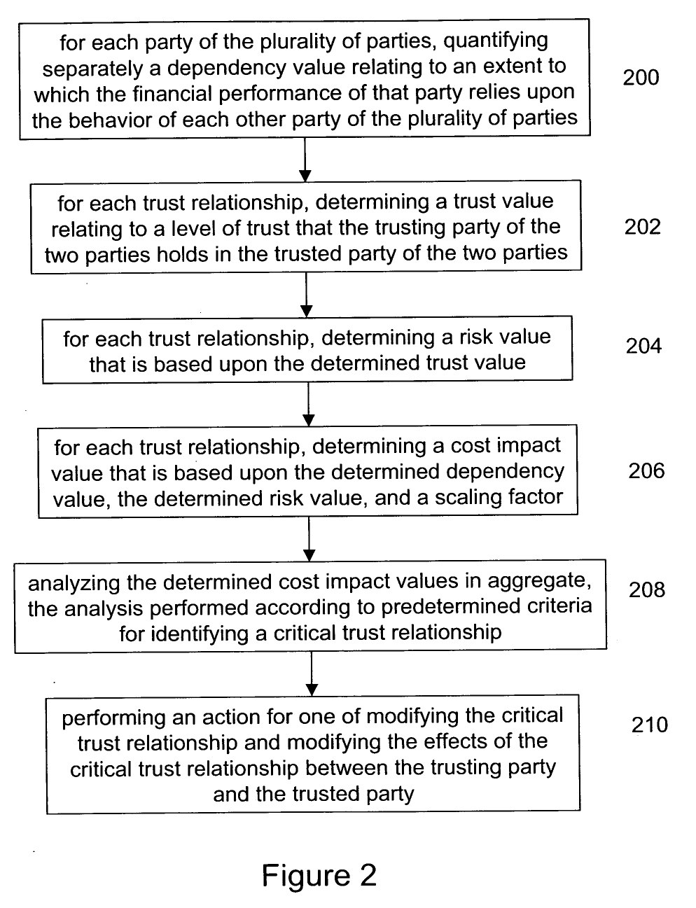

Referring now to FIG. 2, shown is a simplified flow diagram for another method of managing trust relationships within a complex organization, the complex organization comprising a plurality of parties including some parties whose financial performance relies upon the behavior of another party meeting an expectation of trust. At step 200, for each party of the plurality of parties, a dependency value is quantified separately, the dependency value relating to an extent to which the financial performance of that party relies upon the behavior of each other party of the plurality of parties, each non-zero dependency value being indicative of a trust relationship between two parties of the plurality of parties, wherein the two parties include a trusting party and a trusted party. At step 202, for each trust relationship, a trust value is determined, the trust value relating to a level of trust that the trusting party of the two parties holds in the trusted party of the two parties. At step 204, for each trust relationship, a risk value is determined, the risk value based upon the determined trust value. At step 206, for each trust relationship, a cost impact value is determined, the cost impact value based upon the determined dependency value, the determined risk value, and a scaling factor relating to an extent to which the trusting party's compensation is tied to its financial performance. At step 208 the determined cost impact values are analyzed in aggregate, the analysis performed according to predetermined criteria for identifying a critical trust relationship between a trusting party of the plurality of parties and a trusted party of the plurality of parties. At step 210 an action is performed for one of modifying the critical trust relationship and modifying the effects of the critical trust relationship between the trusting party and the trusted party. Some non-limiting examples of actions include:
i) allocating trust building resources for improving the trust relationship between the first party and the second party;
ii) diversifying the first party's dependency on the second party into a plurality of separate dependencies on a plurality of separate parties, each of the plurality of separate dependencies being a one-to-one dependency and having a cost impact value that is smaller than the cost impact value associated with the first party's dependence upon the second party;
iii) adjusting a performance measurement and reward system so as to reduce the scaling factor relating to an extent to which the first party's compensation is tied to its financial performance;
iv) removing one of the first party and the second party from the trust relationship; and,
v) assessing the financial justification of the use of trust building measures for improving trust relationships including the trust relationship between the first party and the second party.

In more particular terms, the risk value f(T) is determined for instance using the formula

f(T)=(rₘₐₓ−rₘᵢₙ)/0.761594*(1−tan h(T))+rₘₐₓ−(rₘₐₓ−rₘᵢₙ)/0.761594

where rₘₐₓ and rₘᵢₙ are determined independently for the first party such that rₘₐₓ expresses the maximum perceived risk in the total absence of trust and rₘᵢₙ expresses the minimum perceived risk despite maximum trust, and T is the determined trust value. In addition, the cost impact value is determined for instance using the formula

Cₚ=cₚ*d*r

where Cₚ is the cost impact value, cₚ is the scaling factor relating to an extent to which the first party's compensation is tied to its financial performance, d is the determined dependency value, and r is the determined risk value.

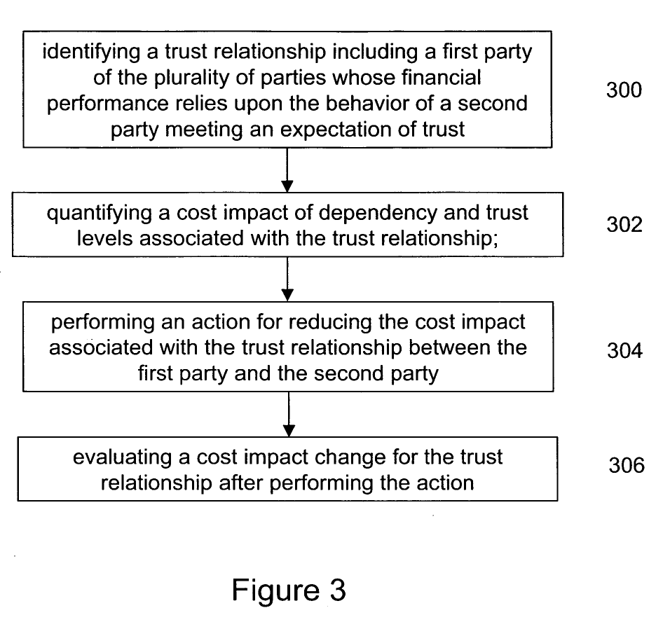

Referring now to FIG. 3, shown is a simplified flow diagram for another method of managing trust relationships within a complex organization, the complex organization comprising a plurality of parties including some parties whose financial performance relies upon the behavior of another party meeting an expectation of trust. At step 300 a trust relationship is identified, the trust relationship including a first party of the plurality of parties whose financial performance relies upon the behavior of a second party meeting an expectation of trust. Step 302 is a quantification of a cost impact of dependency and trust levels associated with the trust relationship. At step 304, an action is performed for reducing the cost impact associated with the trust relationship between the first party and the second party. At step 306 a cost impact change is evaluated for the trust relationship after the action is performed. In particular, the cost impact change is indicative of an effectiveness of the action for improving the trust relationship.

At least one of the embodiments of the instant invention addresses the technical problem relating to managing trust relationships between parties in a complex organization, despite the inherent lack of visibility and transparency typically associated with trust issues. A method according to an embodiment of the instant invention solves this technical problem by assigning values for the cost impact of dependency and trust levels that are associated with trust relationships. The assigned values are useful for targeting and allocating trust building resources to improve critical trust relationships in a complex organization, for taking other steps to reduce the impact of the dependency associated with critical trust relationships, and for evaluating the effectiveness and cost effectiveness of such actions.

Numerous other embodiments may be envisaged without departing from the spirit and scope of the invention.

What is claimed is:

1. A method of managing trust relationships within a complex organization, the complex organization comprising a plurality of parties including some parties whose financial performance relies upon the behavior of another party meeting an expectation of trust, the method comprising:
identifying a first party of the plurality of parties whose financial performance relies upon the behavior of a second party meeting an expectation of trust, the first party and the second party having a trust relationship;
determining a dependency value relating to an extent to which the financial performance of the first party relies upon the behavior of the second party;
determining a trust value relating to a level of trust that the first party holds in the second party;
determining a risk value that is based upon the determined trust value;
determining a cost impact value that is based upon the determined dependency value, the determined risk value, and a scaling factor relating to an extent to which the first party's compensation is tied to its financial performance; and,
performing an action for reducing the cost impact value.

2. A method according to claim 1, wherein the action comprises modifying the trust relationship between the first party and the second party.

3. A method according to claim 1, wherein the action comprises modifying the effects of the trust relationship between the first party and the second party.

4. A method according to claim 1, wherein the action comprises allocating trust building resources for improving the trust relationship between the first party and the second party.

5. A method according to claim 1, wherein the action comprises diversifying the first party's dependency on the second party into a plurality of separate dependencies on a plurality of separate parties, each of the plurality of separate dependencies being a one-to-one dependency and having a cost impact value that is smaller than the cost impact value associated with the first party's dependence upon the second party.

6. A method according to claim 1, wherein the action comprises adjusting a performance measurement and reward system so as to reduce the scaling factor relating to an extent to which the first party's compensation is tied to its financial performance.

7. A method according to claim 1, wherein the action comprises removing one of the first party and the second party from the trust relationship.

8. A method according to claim 1, wherein the action comprises one of reducing a degree of dependency, increasing a level of trust and reducing an impact of the dependency associated with the trust relationship between the first party and the second party.

9. A method according to claim 1, wherein the action comprises assessing the financial justification of the use of trust building measures for improving trust relationships including the trust relationship between the first party and the second party.

10. A method according to claim 1, wherein the cost impact value is determined using the formula
Cₚ=cₚ*d*r
where Cₚ is the cost impact value, cₚ is the scaling factor relating to an extent to which the first party's compensation is tied to its financial performance, d is the determined dependency value, and r is the determined risk value.

11. A method according to claim 1, wherein the risk value f(T) is determined using the formula
f(T)=(rₘₐₓ−rₘᵢₙ)/0.761594*(1−tan h(T))+rₘₐₓ−(rₘₐₓ−rₘᵢₙ)/0.761594
where rₘₐₓ and rₘᵢₙ are determined independently for the first party such that rₘₐₓ expresses the maximum perceived risk in the total absence of trust and rₘᵢₙ expresses the minimum perceived risk despite maximum trust, and T is the determined trust value.

12. A method of managing trust relationships within a complex organization, the complex organization comprising a plurality of parties including some parties whose financial performance relies upon the behavior of another party meeting an expectation of trust, the method comprising:
for each party of the plurality of parties, quantifying separately a dependency value relating to an extent to which the financial performance of that party relies upon the behavior of each other party of the plurality of parties, each non-zero dependency value being indicative of a trust relationship between two parties of the plurality of parties, wherein the two parties include a trusting party and a trusted party;
for each trust relationship, determining a trust value relating to a level of trust that the trusting party of the two parties holds in the trusted party of the two parties;
for each trust relationship, determining a risk value that is based upon the determined trust value;
for each trust relationship, determining a cost impact value that is based upon the determined dependency value, the determined risk value, and a scaling factor relating to an extent to which the trusting party's compensation is tied to its financial performance;
analyzing the determined cost impact values in aggregate, the analysis performed according to predetermined criteria for identifying a critical trust relationship between a trusting party of the plurality of parties and a trusted party of the plurality of parties; and,
performing an action for one of modifying the critical trust relationship and modifying the effects of the critical trust relationship between the trusting party and the trusted party.

13. A method according to claim 12, wherein the action is for modifying the critical trust relationship.

14. A method according to claim 12, wherein the action is for modifying the effects of the critical trust relationship.

15. A method according to claim 12, wherein the action comprises allocating trust building resources for improving the critical trust relationship.

16. A method according to claim 12, wherein the action comprises diversifying the first party's dependency on the second party into a plurality of separate dependencies on a plurality of separate parties, each of the plurality of separate dependencies being a one-to-one dependency and having a cost impact value that is smaller than the cost impact value associated with the first party's dependence upon the second party.

17. A method according to claim 12, wherein the action comprises adjusting a performance measurement and reward system so as to reduce the scaling factor relating to an extent to which the first party's compensation is tied to its financial performance.

18. A method according to claim 12, wherein the action comprises removing one of the first party and the second party from the trust relationship.

19. A method according to claim 12, wherein the action comprises one of reducing a degree of dependency, increasing a level of trust and reducing an impact of the dependency associated with the trust relationship between the first party and the second party.

20. A method according to claim 12, wherein the action comprises assessing the financial justification of the use of trust building measures for improving trust relationships including the trust relationship between the first party and the second party.

21. A method according to claim 12, wherein the cost impact value is determined using the formula
Cₚ=cₚ*d*r
where Cₚ is the cost impact value, cₚ is the scaling factor relating to an extent to which the trusting party's compensation is tied to its financial performance, d is the determined dependency value, and r is the determined risk value.

22. A method according to claim 12, wherein the risk value f(T) is determined using the formula
f(T)=(rₘₐₓ−rₘᵢₙ)/0.761594*(1−tan h(T))+rₘₐₓ−(rₘₐₓ−rₘᵢₙ)/0.761594
where rₘₐₓ and rₘᵢₙ are determined independently for the first party such that rₘₐₓ expresses the maximum perceived risk in the total absence of trust and rₘᵢₙ expresses the minimum perceived risk despite maximum trust, and T is the determined trust value.

23. A method of managing trust relationships within a complex organization, the complex organization comprising a plurality of parties including some parties whose financial performance relies upon the behavior of another party meeting an expectation of trust, the method comprising:
determining a dependency value relating to an extent to which the financial performance of a first party of the plurality of parties relies upon the behavior of a second party of the plurality of parties;
determining a trust value relating to a level of trust that the first party holds in the second party;
determining a risk value that is based upon the determined trust value;
determining a cost impact value that is based upon the determined dependency value, the determined risk value, and a scaling factor relating to an extent to which the first party's compensation is tied to its financial performance; and,
performing an action for one of modifying the trust relationship and modifying the effects of the trust relationship between the first party and the second party.

24. A method according to claim 23, wherein the action is for modifying the trust relationship.

25. A method according to claim 23, wherein the action is for modifying the effects of the trust relationship.

26. A method of managing trust relationships within a complex organization, the complex organization comprising a plurality of parties including some parties whose financial performance relies upon the behavior of another party meeting an expectation of trust, the method comprising:
identifying a trust relationship including a first party of the plurality of parties whose financial performance relies upon the behavior of a second party meeting an expectation of trust;
quantifying a cost impact of dependency and trust levels associated with the trust relationship;
performing an action for reducing the cost impact associated with the trust relationship between the first party and the second party; and,
evaluating a cost impact change for the trust relationship after performing the action, wherein the cost impact change is indicative of an effectiveness of the action for improving the trust relationship.

27. A method according to claim 26, comprising providing a model for use in quantifying the cost impact.

28. A method according to claim 27, comprising in response to evaluating the cost impact change, modifying the model.
